(19) United States
(12) Patent Application Publication
(10) Pub. No.: US 2026/0216977 A1
(43) Pub. Date: Jul. 30, 2026

(54) EMBEDDED CONTACT LENSES WITH SURFACE AND ASTIGMATISM MASKING

(71) Applicant: Alcon Inc., Fribourg (CH)

(72) Inventors: Zahra Bassampour, Alpharetta, GA (US); Richard Charles Breitkopf, Dunwoody, GA (US); Chandana Kolluru, Suwanee, GA (US); Steve Yun Zhang, Sugar Hill, GA (US)

(21) Appl. No.: 19/463,242

(22) Filed: Jan. 29, 2026

Related U.S. Application Data
(60) Provisional application No. 63/751,414, filed on Jan. 30, 2025.

(51) Int. Cl. B29D 11/00; B29K 83/00; B29K 105/00; B29K 233/04; B29L 11/00; G02C 7/04

(52) U.S. Cl. CPC B29D 11/00134; B29D 11/00192; G02C 7/049; B29K 2083/00; B29K 2105/0032; B29K 2233/08; B29L 2011/0041

(57) ABSTRACT

In general, embodiments of the present disclosure relate to pigment containing contact lenses, such as colored contact lenses. In particular, embodiments of the present disclosure relate to a hybrid hard-soft silicone hydrogel contact lens. In at least some embodiments, a method for forming a contact lens is provided. The method includes printing a pigmented layer on a lens mold including an optic zone and curing the pigmented layer with ultraviolet (UV) light. The pigmented layer is printed outside an outer boundary of the optic zone of the lens mold. The method further includes forming an insert lens layer, the insert lens layer disposed on the cured pigmented layer, curing the insert lens layer to form an insert lens having a modulus of greater than about 2 MPa, suspending the insert lens in a lens-forming material and curing the lens-forming material to form a lens body.

### INTRODUCTION

Aspects of the present disclosure relate to the field of vision correction and, more specifically, to pigment containing embedded contact lenses having surface and astigmatism masking capabilities.

### BACKGROUND

Silicone hydrogel (SiHy) contact lenses are widely used for correcting many different types of vision deficiencies. These include defects such as near-sightedness and far-sightedness (myopia and hypermetropia, respectively), defects in near range vision usually associated with aging (presbyopia), and astigmatism vision errors. Astigmatism is an optical power meridian-dependent refractive error in an eye. This is usually due to one or more refractive surfaces, most commonly the anterior cornea, having a toroidal shape. It may also be due to one or more surfaces being transversely displaced or tilted. Astigmatism is usually regular, which means that the principal (maximum and minimum power) meridians are perpendicular to each other. People with astigmatism have blurred vision at all distances, although this may be worse at distance or near, depending on the type of astigmatism. Astigmatism can be corrected with an astigmatic ophthalmic lens, which usually has one spherical surface and one toroidal (cylindrical) surface.

The SiHy contact lenses are made of a hydrated, crosslinked polymeric material that contains silicone and a certain amount of water within the lens polymer matrix at equilibrium. Water in a SiHy contact lens can provide the desirable softness that enables a SiHy lens to be worn for sufficiently long periods of time and provides patients with the benefits including adequate initial comfort (i.e., immediately after lens insertion), relatively short period of time for a patient to become accustomed to the contact lens, and/or proper fit.

In addition, SiHy contact lenses are frequently utilized for cosmetic effect. For example, wearing a colored contact lens on the eye is utilized in an effort to alter the apparent color of the wearer's iris. Colorants such as dyes or pigments of a desired color or colors are applied to a contact lens in a pattern adapted to overlie the natural iris, thereby altering the natural iris color. Such contact lenses may provide vision correction, or may be solely cosmetic. However, the colorants may bleed or diffuse through the bulk material of the contact lens, blurring the pattern and potentially causing discomfort to the wearer due to pigment abrasions on the cornea and the inner eyelid.

Accordingly, there is a need for improved techniques for forming pigment containing contact lenses that can correct astigmatism.

### BRIEF SUMMARY

Embodiments described herein generally relate to pigment containing contact lenses, such as colored contact lenses. In particular, embodiments of the present disclosure relate to a hybrid hard-soft silicone hydrogel contact lens.

Some embodiments provide a method for forming a contact lens. The method includes printing a pigmented layer on a lens mold including an optic zone and curing the pigmented layer with ultraviolet (UV) light. The pigmented layer is printed outside an outer boundary of the optic zone of the lens mold. The method further includes forming an insert lens layer, the insert lens layer disposed on the cured pigmented layer, and curing the insert lens layer to form an insert lens having a modulus of about 2 MPa or greater. The method further includes suspending the insert lens in a lens-forming material and curing the lens-forming material to form a lens body, the insert lens disposed within the lens body.

Some embodiments provide a method for forming a contact lens. The method includes printing a pigmented layer on a back curve of a lens mold and curing the pigmented layer. The method further includes forming an insert lens layer, the insert lens layer disposed on the cured pigmented layer, curing the insert lens layer to form an insert lens having a modulus of about 2 MPa or greater, suspending the insert lens in a lens-forming material, and curing the lens-forming material to form a lens body having a modulus of less than about 2 MPa. The insert lens is disposed within the lens body and includes a pattern disposed on a posterior surface of the insert lens.

Some embodiments provide a contact lens. The contact lens includes a lens body having a modulus of less than about 2 MPa, an insert lens having a modulus of about 2 MPa or greater disposed within the lens body, the insert lens including a curve and a vault of about 80 μm to about 120 μm, and at least one pigmented layer disposed on a posterior surface of the insert lens, where the at least one pigmented layer is embedded within the lens body.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 depicts a peripheral view of an embedded SiHy contact lens, in accordance with some embodiments described herein.

FIG. 2 depicts a frontal view of an embedded SiHy contact lens, in accordance with some embodiments described herein.

FIG. 3 depicts an exploded view of an embedded SiHy contact lens, in accordance with some embodiments described herein.

FIG. 4 is a flow diagram depicting a method for forming an embedded SiHy contact lens, in accordance with some embodiments described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

In general, embodiments of the present disclosure relate to pigment containing contact lenses, such as colored contact lenses. For example, embodiments of the present disclosure relate to a hybrid hard-soft SiHy contact lens having a layer of pigment printed on a hard insert lens that is encapsulated by a soft lens body, preventing wearer discomfort by preventing pigment abrasions on the eye or inner eyelid, and methods for forming the same. In at least some embodiments, the hard insert lens masks the abnormal shape of astigmatic corneas, as the embedded hard insert lens does not conform to the shape of the cornea. In some embodiments, a method includes forming a hard insert lens having a pigmented ink, such as a UV curable ink, printed on the base curve (e.g. the posterior surface) of the hard insert lens, and suspending the hard insert lens in a soft lens body.

Reference will now be made in detail to the embodiments of the disclosure. It will be apparent to those skilled in the art that various modifications, variations and combinations can be made in the present disclosure without departing from the scope or spirit of the disclosure. For instance, features illustrated or described as part of one embodiment, can be used on another embodiment to yield still further embodiments. Thus, it is intended that the present disclosure cover such modifications, variations and combinations as come within the scope of the appended claims and their equivalents. Other objects, features and aspects of the present disclosure are disclosed in or are obvious from the following detailed description. It is to be understood by one of ordinary skill in the art that the present discussion is a description of exemplary embodiments only, and is not intended as limiting the broader aspects of the present disclosure.

Unless defined otherwise, all technical and scientific terms used herein have the same meaning as commonly understood by one of ordinary skill in the art to which this disclosure belongs. Generally, the nomenclature used herein and the laboratory procedures are well known and commonly employed in the art. Conventional methods are used for these procedures, such as those provided in the art and various general references. Where a term is provided in the singular, the disclosure also contemplates the plural of that term. The nomenclature used herein and the laboratory procedures described below are those known and commonly employed in the art.

As used in this application, the term “silicone hydrogel contact lens” refers to a contact lens comprising a silicone hydrogel material.

As used in this application, the term “contact lens” refers to an object that can be placed on or within a wearer's eye. A contact lens can correct, improve, or alter a user's eyesight, but that need not be the case. A contact lens can be of any appropriate material known in the art or later developed, and can be a soft lens, a hard lens, or a hybrid lens. A contact lens can be tinted before printing any color patterns. A contact lens can be in a dry state or a wet state. “Dry State” refers to a soft lens in a state prior to hydration or the state of a hard lens under storage or use conditions. “Wet State” refers to a soft lens in a hydrated state.

The “front surface” or “anterior surface” of a contact lens, as used herein, refers to the surface of the lens that faces away from the eye during wear. The anterior surface, which is typically substantially convex, may also be referred to as the front curve of the lens.

The “rear surface” or “posterior surface” of a contact lens, as used herein, refers to the surface of the lens that faces towards the eye during wear. The rear surface, which is typically substantially concave, may also be referred to as the base curve of the lens.

As used in this application, the term “hydrogel” or “hydrogel material” refers to a crosslinked polymeric material which is not water-soluble and can contain at least 10% by weight of water within its polymer matrix when fully hydrated.

As used in this application, the term “silicone hydrogel” refers to a hydrogel containing silicone. A silicone hydrogel typically is obtained by copolymerization of a polymerizable composition comprising at least one silicone-containing vinylic monomer or at least one silicone-containing vinylic macromer or at least one silicone-containing prepolymer having ethylenically unsaturated groups.

As used in this application, the term “lens-forming material” refers to a polymerizable composition which can be cured (i.e., polymerized and/or crosslinked) thermally or actinically (e.g., by actinic radiation) to obtain a crosslinked polymer. Examples of actinic radiation are UV irradiation, ionized radiation (e.g., gamma ray or X-ray irradiation), microwave irradiation, and the like.

As used in this application, the term “vinylic monomer” refers to a compound that has one sole ethylenically unsaturated group and can be polymerized actinically or thermally.

As used in this application, the term “olefinically unsaturated group” or “ethylenically unsaturated group” is employed herein in a broad sense and is intended to encompass any groups containing at least one >C═C< group. Some example ethylenically unsaturated groups include (meth)acryloyl

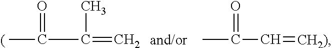

allyl, vinyl

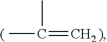

styrenyl, or other C═C containing groups.

As used in this application, the term “(meth)acrylamide” refers to methacrylamide and/or acrylamide.

As used in this application, the term “(meth)acrylate” refers to methacrylate and/or acrylate.

As used in this application, the term “hydrophilic vinylic monomer” refers to a vinylic monomer, which as a homopolymer typically yields a polymer that is water-soluble or can absorb at least 10 percent by weight water.

As used in this application, the term “hydrophobic vinylic monomer” refers to a vinylic monomer which as a homopolymer typically yields a polymer that is insoluble in water and can absorb less than 10 percent by weight water.

As used in this application, the term “macromer” or “prepolymer” refers to a medium and high molecular weight compound or polymer that contains two or more ethylenically unsaturated groups. Medium and high molecular weight typically means average molecular weights greater than 700 Daltons.

As used in this application, the term “crosslinker” refers to a compound having at least two ethylenically unsaturated groups. A “crosslinking agent” refers to a crosslinker having a molecular weight of about 700 Daltons or less.

As used in this application, the term “photoinitiator” refers to a chemical that initiates radical crosslinking/polymerizing reaction by the use of light. Suitable photoinitiators include benzoin methyl ether, diethoxyacetophenone, a benzoylphosphine oxide, 1-hydroxycyclohexyl phenyl ketone, Darocure® types, and Irgacure® types, such as Darocure® 1173, and Irgacure® 2959.

As used in this application, the term “thermal initiator” refers to a chemical that initiates radical crosslinking/polymerizing reaction by the use of heat energy. Examples of suitable thermal initiators include 2,2′-azobis(2,4-dimethylpentanenitrile), 2,2′-azobis(2-methylpropanenitrile), 2,2′-azobis(2-methylbutanenitrle), peroxides such as benzoyl peroxide, and the like. For example, the thermal initiator is 2,2′-azobis(isobutyronitrile) (AIBN).

As used in this application, the term “polymer” means a material formed by polymerizing/crosslinking one or more monomers or macromers or prepolymers.

As used in this application, the term “molecular weight” of a polymeric material (including monomeric or macromeric materials) refers to the weight-average molecular weight unless otherwise specifically noted or unless testing conditions indicate otherwise.

As used in this application, the term “amino group” refers to a primary or secondary amino group of formula —NHR′, where R′ is hydrogen or a C₁-C₂₀ unsubstituted or substituted, linear or branched alkyl group, unless otherwise specifically noted.

As used in this application, the term “thermally-crosslinkable” in reference to a polymeric material or a functional group means that the polymeric material or the functional group can undergo a crosslinking (or coupling) reaction with another material or functional group at a relatively-elevated temperature (about 40° C. to about 140° C.), whereas the polymeric material or functional group cannot undergo the same crosslinking reaction (or coupling reaction) with another material or functional group at room temperature (about 22° C. to about 28° C., such as from about 24° C. to about 26° C., in particular at about 25° C.) to an extent detectable (i.e., greater than about 5%) for a period of about one hour.

As used in this application, the term “reactive vinylic monomer” refers to a vinylic monomer having a carboxyl group or an amino group (e.g., a primary or secondary amino group).

As used in this application, the term “non-reactive hydrophilic vinylic monomer” refers to a hydrophilic vinylic monomer, which is free of any carboxyl group or amino group (e.g., primary or secondary amino group). A non-reactive vinylic monomer can include a tertiary or quaternium amino group.

As used in this application, the term “water-soluble” in reference to a polymer means that the polymer can be dissolved in water to an extent sufficient to form an aqueous solution of the polymer having a concentration of up to about 30% by weight at room temperature (defined above).

As used in this application, the term “compatible” or “ophthalmically compatible” refers to a material or surface of a material which may be in intimate contact with the ocular environment for an extended period of time without significantly damaging the ocular environment and without significant user discomfort.

As used in this application, the term “safe” or “ophthalmically safe” with respect to a packaging solution for sterilizing and storing contact lenses is intended to mean that a contact lens stored in the solution is safe for direct placement on the eye without rinsing after autoclave and that the solution is safe and sufficiently comfortable for daily contact with the eye via a contact lens. An ophthalmically-safe packaging solution after autoclave has a tonicity and a pH that are compatible with the eye and is substantially free of ocularly irritating or ocularly cytotoxic materials according to international ISO standards and U.S. FDA regulations.

As used in this application, the term “pigment” means a substance that is used to impart color. A non-limiting example of a pigment is a “dye,” a substance that is soluble in a solvent and that is used to impart color. Dyes are typically transparent or translucent and absorb but do not scatter light. Dyes can cover both optical regions of contact lenses and non-optical regions of contact lenses. Another non-limiting example of a pigment is a powdered substance that is suspended in a liquid in which it is insoluble. Suspended pigments (e.g. insoluble substances), in general, are more opaque than dyes.

In general, embodiments of the present disclosure relate to pigment containing contact lenses, such as colored contact lenses. In particular, embodiments of the present disclosure relate to a hybrid hard-soft SiHy contact lens having a layer of pigment printed on a hard insert lens that is encapsulated by a soft lens body, preventing wearer discomfort by preventing pigment abrasions on the eye or inner eyelid. In at least some embodiments, the hard insert lens masks abnormal shapes of astigmatic corneas, as the embedded hard insert lens creates a vaulted structure that sits above the abnormally shaped cornea, and does not conform to the shape of the cornea.

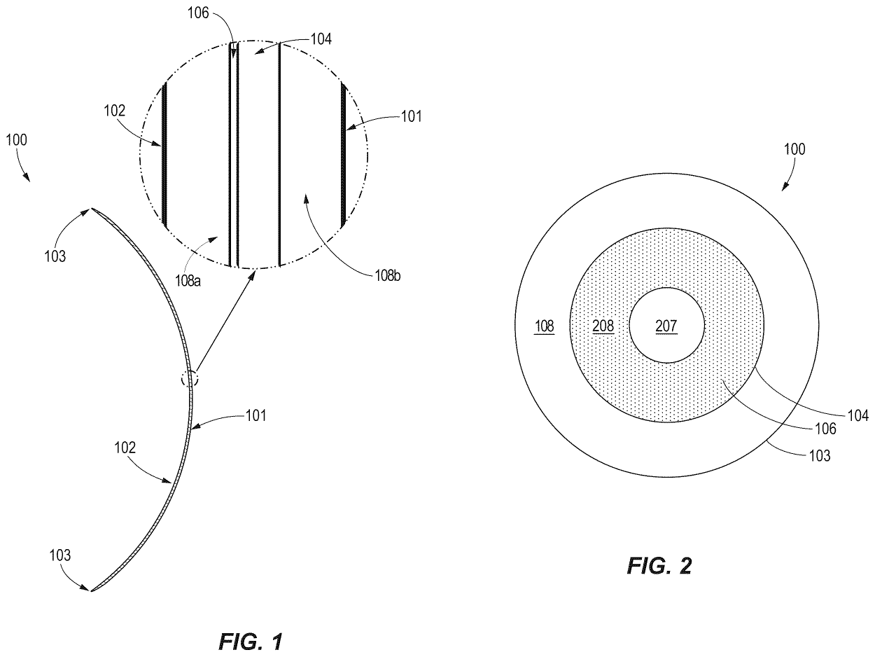

FIG. 1 depicts an embedded SiHy contact lens, according to some embodiments. In accordance with some embodiments, the SiHy contact lens 100 has an anterior surface (or front curve or convex surface) 101 and an opposite posterior surface (or base curve or concave surface) 102 which rests on the cornea of the eye when worn by a user. The SiHy contact lens 100 includes a lens-forming material 108, a pigmented layer 106, and an insert lens layer 104. The lens-forming material 108 is the bulk material of the SiHy contact lens 100 and has a 3-dimensional shape very close to the SiHy contact lens 100. In some embodiments, the lens-forming material 108 may include a silicone hydrogel. The pigmented layer 106 is disposed on the posterior surface (or base curve) of the insert lens layer 104, such that the pigmented layer 106 is on the inner surface of the insert lens layer 104 proximate the eye of the wearer (relative to the insert lens layer 104). The pigmented layer 106 and the insert lens layer 104 are embedded within the lens-forming material 108. The posterior lens-forming material 108a merges with the anterior lens-forming material 108b at the peripheral edge 103 of the SiHy contact lens 100, to cover and encapsulate the pigmented layer 106 and the insert lens layer 104. Advantageously, the lens-forming material 108 provides a barrier between the pigmented layer 106 and the eye and inner eyelid of the wearer, thus preventing pigment abrasion.

FIG. 2 depicts a frontal view of an embedded SiHy contact lens, according to some embodiments. The SiHy contact lens 100 includes an optic zone 207 and an iris portion 208 surrounding the optic zone 207. The iris portion 208 is generally annular and is defined as the portion of the SiHy contact lens that, when worn, covers the wearer's iris or the colored portion of the eye. The pigmented layer 106 may be printed outside of the optic zone 207 in at least the iris portion 208 of the SiHy contact lens 100 so as not to obstruct the optic zone 207. In at least some embodiments, the pigmented layer 106 may extend past the iris portion 208 toward the peripheral edge 103 of the SiHy contact lens 100, such that, when worn, the pigmented layer covers at least a portion of the wearer's sclera. In at least some embodiments, the pigmented layer 106 includes a UV curable ink printed in a desired pattern. The UV curable ink may include opaque suspended pigments and/or dyes. The pattern may be any suitable pattern for cosmetic or medical contact lenses. In at least one embodiment, examples of suitable patterns include an outer starburst pattern, an inner starburst patter, and a limbal ring. In some embodiments, the pigmented layer 106 includes multiple individually printed patterns layered on top of one another to form a more complex pattern. The pigmented layer 106 may include any number of individually printed pigmented layers having individual patterns, such as two or more, three or more, four or more, or five or more.

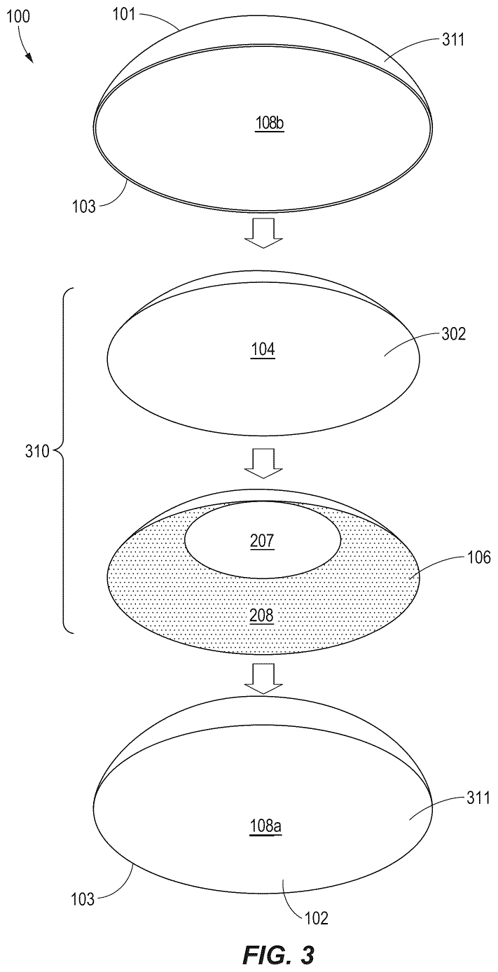

FIG. 3 depicts an exploded view of an embedded SiHy contact lens, according to some embodiments. In some embodiments, the insert lens layer 104 is disposed in the optic zone 207 and the iris portion 208 of the SiHy contact lens 100. In at least some embodiments, the insert lens layer 104 is disposed in the optic zone 207 and extends past the iris portion 208 of the SiHy contact lens 100. The insert lens 310 (also referred to as the hard insert lens 310) includes the insert lens layer 104 and the pigmented layer 106 disposed on the posterior surface 302 of the insert lens layer 104. The insert lens 310 is a hard lens having a rigid curve that does not conform to the shape of the cornea of the wearer, instead the hard insert lens 310 supports vaulting of the SiHy contact lens 100 over the cornea of the wearer, advantageously masking any abnormalities in the shape of astigmatic corneas. A hard lens, such as the hard insert lens 310, is a lens having a modulus of about 2 MPa or greater, such as about 2 MPa to about 10 MPa, such as about 2 MPa to about 3 MPa, alternatively about 3 MPa to about 4 MPa, alternatively about 4 MPa to about 5 MPa, alternatively about 5 MPa to about 6 MPa, alternatively about 6 MPa to about 7 MPa, alternatively about 7 MPa to about 8 MPa, alternatively about 8 MPa to about 9 MPa, alternatively about 9 MPa to about 10 MPa. The hard insert lens 310 creates a vaulted structure that sits above the cornea of the wearer, creating a space between the SiHy contact lens 100 and the cornea. The space may be filled with tear fluid that takes on the shape defined by the hard insert lens 310, masking any abnormalities that may exist in the cornea of the wearer. In at least some embodiments, the SiHy contact lens 100 has a vault (e.g. the space between the contact lens and the cornea) of about 80 μm to about 120 μm, such as about 100 μm, due to the curve of the hard insert lens 310. In at least some embodiments, a vault of about 100 μm may be used to mask a 0.25 diopter (D) to about 0.75 D, such as about 0.5 D, anterior corneal astigmatism. The hard insert lens 310 is disposed within a lens body, the soft lens body 311 that includes the posterior lens-forming material 108a and the anterior lens-forming material 108b. The soft lens body 311 has a modulus of less than about 2 MPa.

In at least some embodiments, the embedded hard insert lens 310 aids in trapping the pigmented layer 106, preventing the pigmented layer 106 from defusing towards or otherwise contacting the eye of the wearer, as the pigmented layer 106 is fully embedded within soft lens body 311. The encapsulation of the pigmented layer 106 prevents pigment abrasions on the eye or inner eyelid, leading to a more comfortable SiHy contact lens 100. In at least some embodiments, the soft lens body 311 provides a cushion between the hard insert lens and the eye of the wearer, thus providing softness and comfort that enables the SiHy contact lens 100 to be worn for sufficiently long periods of time. Additionally, in at least some embodiments, the soft lens body 311 may be used to introduce smart coatings to the contact lens surface.

In at least one embodiment, the SiHy contact lens 100 includes a soft lens body 311, a hard insert lens 310, and at least one pigmented layer 106. The hard insert lens 310 is disposed within the soft lens body 311 and includes a rigid curve. The at least one pigmented layer 106 is disposed on the posterior surface 302 of the hard insert lens and is embedded within the soft lens body 311.

In at least some embodiments, the pigmented layer 106 is printed using a UV curable ink. The UV curable ink may include pigments, a UV-curable binder, monomer(s), a solvent, and a photoinitiator. In at least some embodiments, the UV-curable binder may include ethylenically unsaturated groups and segments derived from at least one silicone-containing vinylic monomer or macromere. The UV curable ink may include monomer(s), such as a hydrophilic vinylic monomer, a hydrophobic vinylic monomer, or combinations thereof, as described below. For example, in at least some embodiments, the UV curable ink includes about 30 wt % to about 40 wt % of cobalt binder, about 1 wt % to about 15 wt % of black iron oxide, about 0.1 wt % to about 5 wt % of a photoinitiator such as Darocur 1173, and a solvent such as 1-propanol.

Examples of pigments suitable for use in the UV curable ink include any colorant permitted in medical devices and approved by the FDA, such as D&C Blue No. 6, D&C Green No. 6, D&C Violet No. 2, carbazole violet, certain copper complexes, certain chromium oxides, various iron oxides, phthalocyanine (PCN) green, phthalocyanine (PCN) blue, titanium dioxides, etc., or combinations thereof. In at least some embodiments, the pigment may include (C.I. is the color index no.), for a blue color, phthalocyanine blue (pigment blue 15:3, C.I. 74160), cobalt blue (pigment blue 36, C.I. 77343), Toner cyan BG (Clariant), Permajet blue B2G (Clariant); for a green color, phthalocyanine green (Pigment green 7, C.I. 74260) and chromium sesquioxide; for yellow, red, brown and black colors, various iron oxides; PR122, PY154, for violet, carbazole violet; for black, Monolith black C-K (CIBA Specialty Chemicals).

In at least some embodiments, an insert lens formulation for the insert lens layer 104, which forms the hard insert lens 310, generally includes at least one of a silicone-containing vinylic monomer, a silicone-containing vinylic macromer, a silicone-containing prepolymer, a hydrophilic vinylic monomer, a hydrophobic vinylic monomer, a crosslinking agent (a compound having a molecular weight of about 700 Daltons or less and containing at least two ethylenically unsaturated groups), a free-radical initiator (photoinitiator or thermal initiator), a hydrophilic vinylic macromer/prepolymer, or combinations thereof. The insert lens formulation is formulated such that, when cured, the insert lens layer 104 is a hard solid polymer.

Any suitable silicone-containing vinylic monomers may be used in formulating the insert lens layer 104 and/or the UV curable ink. Examples of silicone-containing vinylic monomers include N-[tris(trimethylsiloxy)silylpropyl]-(meth)acrylamide, N-[tris(dimethylpropylsiloxy)-silylpropyl]-(meth)acrylamide, N-[tris(dimethylphenylsiloxy)silylpropyl](meth)acrylamide, N-[tris(dimethylethylsiloxy)silylpropyl](meth)acrylamide, N-(2-hydroxy-3-(3-(bis(trimethylsilyloxy)methylsilyl)propyloxy)propyl)-2-methyl acrylamide; N-(2-hydroxy-3-(3-(bis(trimethylsilyloxy)methylsilyl)propyloxy)propyl)acrylamide; N,N-bis[2-hydroxy-3-(3-(bis(trimethylsilyloxy)methylsilyl)propyloxy)propyl]-2-methyl acrylamide; N,N-bis[2-hydroxy-3-(3-(bis(trimethylsilyloxy)methylsilyl)propyloxy)propyl]acrylamide; N-(2-hydroxy-3-(3-(tris(trimethylsilyloxy)silyl)propyloxy)propyl)-2-methyl acrylamide; N-(2-hydroxy-3-(3-(tris(trimethylsilyloxy)silyl)propyloxy)propyl)acrylamide; N,N-bis[2-hydroxy-3-(3-(tris(trimethylsilyloxy)silyl)propyloxy)propyl]-2-methyl acrylamide; N,N-bis[2-hydroxy-3-(3-(tris(trimethylsilyloxy)silyl)propyloxy)propyl]acrylamide; N-[2-hydroxy-3-(3-(t-butyldimethylsilyl)propyloxy)propyl]-2-methyl acrylamide; N-[2-hydroxy-3-(3-(t-butyldimethylsilyl)propyloxy)propyl]acrylamide; N,N-bis[2-hydroxy-3-(3-(t-butyldimethylsilyl)propyloxy)propyl]-2-methyl acrylamide; N,N-bis[2-hydroxy-3-(3-(t-butyldimethylsilyl)propyloxy)propyl]acrylamide; 3-methacryloxy propylpentamethyldisiloxane, tris(trimethylsilyloxy)silylpropyl methacrylate (TRIS), (3-methacryloxy-2-hydroxypropyloxy)propylbis(trimethylsiloxy)methylsilane), (3-methacryloxy-2-hydroxypropyloxy)propyltris(trimethylsiloxy) silane, 3-methacryloxy-2-(2-hydroxyethoxy)-propyloxy)propylbis(trimethylsiloxy)methylsilane, N-2-methacryloxyethyl-O-(methyl-bistrimethylsiloxy-3-propyl)silylcarbamate, 3-(trimethylsilyl)propylvinyl carbonate, 3-(vinyloxycarbonylthio)propyl-tris(trimethyl-siloxy) silane, 3-[tris(trimethylsiloxy)silyl]propylvinyl carbamate, 3-[tris(trimethylsiloxy)silyl]propylallyl carbamate, 3-[tris(trimethylsiloxy)silyl]propyl vinyl carbonate, t-butyldimethyl-siloxyethyl vinyl carbonate, trimethylsilylethyl vinyl carbonate, and trimethylsilylmethylvinyl carbonate. Some example siloxane-containing (meth)acrylamide monomers are N-[tris(trimethylsiloxy)silylpropyl]acrylamide, TRIS, N-[2-hydroxy-3-(3-(tbutyldimethylsilyl)propyloxy)propyl]acrylamide, or combinations thereof.

A class of silicone-containing vinylic monomers or macromers is polysiloxane-containing vinylic monomers or macromers. Examples of such polysiloxane-containing vinylic monomers or macromers are monomethacrylated or monoacrylated polydimethylsiloxanes of various molecular weight (e.g., mono-3-methacryloxypropyl terminated, mono-butyl terminated polydimethylsiloxane or mono-(3-methacryloxy-2-hydroxypropyloxy)propyl terminated, mono-butyl terminated polydimethylsiloxane); dimethacrylated or diacrylated polydimethylsiloxanes of various molecular weight; vinyl carbonate-terminated polydimethylsiloxanes; vinyl carbamate-terminated polydimethylsiloxane; vinyl terminated polydimethylsiloxanes of various molecular weight; methacrylamide-terminated polydimethylsiloxanes; acrylamide-terminated polydimethylsiloxanes; acrylate-terminated polydimethylsiloxanes; methacrylateterminated polydimethylsiloxanes; bis-3-methacryloxy-2-hydroxypropyloxypropyl polydimethylsiloxane; N,N,N′,N′tetrakis(3-methacryloxy-2-hydroxypropyl)-alpha, omegabis-3-aminopropyl-polydimethylsiloxane; polysiloxanylalkyl (meth)acrylic monomers; siloxane-containing macromer selected from Macromer A, Macromer B, Macromer C, and Macromer D described in U.S. Pat. No. 5,760,100 (herein incorporated by reference in its entirety); the reaction products of glycidyl methacrylate with amino-functional polydimethylsiloxanes; hydroxyl-functionalized siloxane-containing vinylic monomers or macromers; polysiloxane-containing macromers; polysiloxane-containing macromers, or combinations thereof. Di and triblock macromers such as polydimethylsiloxane and polyalkyleneoxides could also be of utility. For example, one might use methacrylate end capped polyethyleneoxide-block-polydimethylsiloxane-block-polyethyleneoxide to enhance oxygen permeability. Suitable monofunctional hydroxyl-functionalized siloxane-containing vinylic monomers/macromers and suitable multifunctional hydroxylfunctionalized siloxane-containing vinylic monomers/macromers are commercially available from Gelest, Inc, Morrisville, Pa.

Another class of silicone-containing macromers is silicone-containing prepolymers comprising hydrophilic segments and hydrophobic segments. Any suitable of silicone-containing prepolymers with hydrophilic segments and hydrophobic segments may be used.

Examples of hydrophilic vinylic monomers are N,N-dimethylacrylamide (DMA), N,N-dimethylmethacrylamide (DMMA), 2-acrylamidoglycolic acid, 3-acryloylamino-1-propanol, N-hydroxyethyl acrylamide, N-[tris(hydroxymethyl)methyl]-acrylamide, N-methyl-3-methylene-2-pyrrolidone, 1-ethyl-3-methylene-2-pyrrolidone, 1-methyl-5-methylene-2-pyrrolidone, 1-ethyl-5-methylene-2-pyrrolidone, 5-methyl-3-methylene-2-pyrrolidone, 5-ethyl-3-methylene-2-pyrrolidone, 1-n-propyl-3-methyl-ene-2-pyrrolidone, 1-n-propyl-5-methylene-2-pyrrolidone, 1-isopropyl-3-methylene-2-pyrrolidone, 1-isopropyl-5-methylene-2-pyrrolidone, 1-n-butyl-3-methylene-2-pyrrolidone, 1-tert-butyl-3-methylene-2-pyrrolidone, 2-hydroxyethyl methacrylate (HEMA), 2-hydroxyethyl acrylate (HEA), hydroxypropyl acrylate, hydroxypropyl methacrylate (HPMA), trimethylammonium 2-hydroxy propylmethacrylate hydrochloride, aminopropyl methacrylate hydrochloride, dimethylaminoethyl methacrylate (DMAEMA), glycerol methacrylate (GMA), N-vinyl-2-pyrrolidone (NVP), allyl alcohol, vinylpyridine, a C₁-C₄-alkoxy polyethylene glycol (meth)acrylate having a weight average molecular weight of up to 1500, methacrylic acid, N-vinyl formamide, N-vinyl acetamide, N-vinyl isopropylamide, N-vinyl-N-methyl acetamide, allyl alcohol, N-vinyl caprolactam, and combinations thereof.

Examples of hydrophobic vinylic monomers include methylacrylate, ethyl-acrylate, propylacrylate, isopropylacrylate, cyclohexylacrylate, 2-ethylhexylacrylate, methyl methacrylate (MMA), ethylmethacrylate, propylmethacrylate, vinyl acetate, vinyl propionate, vinyl butyrate, vinyl valerate, styrene, chloroprene, vinyl chloride, vinylidene chloride, acrylonitrile, I-butene, butadiene, methacrylonitrile, vinyl toluene, vinyl ethyl ether, perfluorohexylethyl-thio-carbonylaminoethylmethacrylate, isobornyl methacrylate, trifluoroethyl methacrylate, hexafluoro-isopropyl methacrylate, hexafluorobutyl methacrylate, or combinations thereof.

Examples of cross-linking agents include tetraethyleneglycol diacrylate, triethyleneglycol diacrylate, ethyleneglycol diacylate, diethyleneglycol diacrylate, tetraethyleneglycol dimethacrylate, triethyleneglycol dimethacrylate, ethyleneglycol dimethacylate, diethyleneglycol dimethacrylate, trimethylopropane trimethacrylate, pentaerythritol tetramethacrylate, neopentyl glycol dimethacrylate, bisphenol A dimethacrylate, vinyl methacrylate, ethylenediamine dimethyacrylamide, ethylenediamine diacrylamide, glycerol dimethacrylate, triallyl isocyanurate, triallyl cyanurate, allylmethacrylate, allylmethacrylate, 1,3-bis(methacrylamidopropyl)-1,1,3,3-tetrakis(trimethylsiloxy)disiloxane, N,N′methylenebisacrylamide, N,N′methylenebismethacrylamide, N,N′-ethylenebisacrylamide, N,N′-ethylenebismethacrylamide, 1,3-bis(N-methacrylamidopropyl)-1,1,3,3-tetrakis-(trimethylsiloxy)disiloxane, 1,3-bis(methacrylamidobutyl)-1,1,3,3-tetrakis(trimethylsiloxy)disiloxane, 1,3-bis(acrylamidopropyl)-1,1,3,3-tetrakis(trimethylsiloxy)disiloxane, 1,3-bis(methacryloxyethylureidopropyl)-1,1,3,3-tetrakis(trimethylsiloxy)disiloxane, and combinations thereof. An example cross-linking agent is tetra(ethyleneglycol)diacrylate, tri(ethyleneglycol)diacrylate, ethyleneglycol diacrylate, di(ethyleneglycol)diacrylate, methylenebisacrylamide, triallyl isocyanurate, or triallyl cyanurate. The amount of a crosslinking agent used is expressed in the weight content with respect to the total polymer and can be about 0.05 wt % to about 4 wt %, such as about 0.1 wt % to about 2 wt %.

Examples of suitable thermal initiators include 2,2′-azobis(2,4-dimethylpentanenitrile), 2,2′-azobis(2-methylpropanenitrile), 2,2′-azobis(2-methylbutanenitrile) (AMBN), peroxides such as benzoyl peroxide, the thermal initiator is 2,2′-azobis(isobutyronitrile) (AIBN), and combinations thereof.

Suitable photoinitiators for formulating the insert lens layer 104 and/or the UV curable ink are benzoin methyl ether, diethoxyacetophenone, a benzoylphosphine oxide, 1-hydroxycyclohexyl phenyl ketone and F and Irgacur types, for example, Darocur 1173®, Irgacur 2959®, and combinations thereof. Examples of benzoylphosphine initiators include 2,4,6-trimethylbenzoyldiphenylophosphine oxide; bis-(2,6-dichlorobenzoyl)-4-N-propylphenylphosphine oxide; and bis-(2,6-dichlorobenzoyl)-4-N-butylphenylphosphine oxide. Reactive photoinitiators, which can be incorporated, for example, into a macromer or can be used as a special monomer are also suitable. The polymerization can then be triggered by actinic radiation, for example light, in particular UV light of a suitable wavelength. The spectral requirements can be controlled accordingly, if appropriate, by addition of suitable photosensitizers.

In at least some embodiments, the insert lens layer 104 and the hard insert lens 310 include a polymer formed from hexafluoroisopropyl methacrylate, neopentylglycol dimethacrylate, MMA, DMA, isobornyl methacrylate, TRIS, a polydimethylsiloxane, or any combinations thereof. In at least some embodiments, the insert lens layer 104 and the hard insert lens 310 include hexafluoroisopropyl methacrylate units, neopentylglycol dimethacrylate units, and TRIS units. The insert lens layer 104 may include about 30 wt % to about 60 wt % of hexafluoroisopropyl methacrylate units, such as about 35 wt % to about 60 wt %, about 40 wt % to about 50 wt %, or about 45 wt % to about 50 wt %. The insert lens layer 104 may further include about 5 wt % to about 30 wt % of neopentylglycol dimethacrylate units, such as about 5 wt % to about 25 wt %, about 5 wt % to about 20 wt %, about 5 wt % to about 15 wt %, about 5 wt % to about 10 wt %, about 10 wt % to about 25 wt %, or about 10 wt % to about 20 wt %. The insert lens layer 104 may further include about 30 wt % to about 60 wt % of TRIS units, such as about 35 wt % to about 60 wt %, about 40 wt % to about 50 wt %, or about 45 wt % to about 50 wt %. In at least some embodiments, the insert lens layer 104 may further include about 0.1 wt % to about 5 wt % of pentaerythritol acrylate units. In at least one embodiment, the insert lens layer 104 may further include an RB247/CuP dispersion, where RB247 is Reactive Blue 247. The hard insert lens 310 may include about 30 wt % to about 60 wt % of hexafluoroisopropyl methacrylate units, such as about 35 wt % to about 60 wt %, about 40 wt % to about 50 wt %, or about 45 wt % to about 50 wt %. The hard insert lens 310 may further include about 5 wt % to about 30 wt % of neopentylglycol dimethacrylate units, such as about 5 wt % to about 25 wt %, about 5 wt % to about 20 wt %, about 5 wt % to about 15 wt %, about 5 wt % to about 10 wt %, about 10 wt % to about 25 wt %, or about 10 wt % to about 20 wt %. The hard insert lens 310 may further include about 30 wt % to about 60 wt % of TRIS units, such as about 35 wt % to about 60 wt %, about 40 wt % to about 50 wt %, or about 45 wt % to about 50 wt %. In at least some embodiments, the hard insert lens 310 may further include about 0.1 wt % to about 5 wt % of pentaerythritol acrylate units. In at least one embodiment, the hard insert lens 310 may further include an RB247/CuP dispersion, where RB247 is Reactive Blue 247.

In at least some embodiments, the insert lens layer 104 and the hard insert lens 310 include a polymer formed from a polydimethylsiloxane, such as D6, a low Mw polymer of chain-extended polydimethyl siloxane (CEPDMS), MMA, and isobornyl methylacrylate. D6 represents a monobutyl-terminated monomethacryloxypropyl-terminated polydimethylsiloxane (Mw~761 g/mol from Shin-Etsu). Low Mw CEPDMS represents a di-methacrylate-terminated chain-extended polydimethyl siloxane (Mw~6000 g/mol), which has three polydimethylsiloxane (PDMS) segments linked via diurethane linkages between two PDMS segments and two urethane linkages each located between one terminal methacrylate group and one PDMS segment. The insert lens layer 104 may include about 10 wt % to about 30 wt % of D6 units, such as about 12.5 wt % to about 25 wt %, about 12.5 wt % to about 20 wt %, or about 15 wt % to about 20 wt %. The insert lens layer 104 may further include about 10 wt % to about 30 wt % of a low Mw CEPDMS units, such as about 12.5 wt % to about 25 wt %, about 12.5 wt % to about 20 wt %, or about 15 wt % to about 20 wt %. The insert lens layer 104 may further include about 15 wt % to about 35 wt % of MMA units, such as about 15 wt % to about 30 wt %, about 20 wt % to about 30 wt %, or about 25 wt % to about 30 wt %. The insert lens layer 104 may further include about 15 wt % to about 35 wt % of isobornyl methylacrylate units, such as about 15 wt % to about 30 wt %, about 20 wt % to about 30 wt %, or about 25 wt % to about 30 wt %. In at least some embodiments, the insert lens layer 104 may further include DMA units and neopentylglycol dimethacrylate units. The hard insert lens 310 may include about 10 wt % to about 30 wt % of D6 units, such as about 12.5 wt % to about 25 wt %, about 12.5 wt % to about 20 wt %, or about 15 wt % to about 20 wt %. The hard insert lens 310 may further include about 10 wt % to about 30 wt % of a low Mw CEPDMS units, such as about 12.5 wt % to about 25 wt %, about 12.5 wt % to about 20 wt %, or about 15 wt % to about 20 wt %. The hard insert lens 310 may further include about 15 wt % to about 35 wt % of MMA units, such as about 15 wt % to about 30 wt %, about 20 wt % to about 30 wt %, or about 25 wt % to about 30 wt %. The hard insert lens 310 may further include about 15 wt % to about 35 wt % of isobornyl methylacrylate units, such as about 15 wt % to about 30 wt %, about 20 wt % to about 30 wt %, or about 25 wt % to about 30 wt %. In at least some embodiments, the hard insert lens 310 may further include DMA units and neopentylglycol dimethacrylate units.

In accordance with the disclosure, the lens-forming material 108 of the SiHy contact lens 100 forms the soft lens body 311 and may be referred to as the bulk material or bulk layer of the lens. In at least some embodiments, a SiHy lens formulation for the lens-forming material 108 generally includes at least one of a silicone-containing vinylic monomer, a silicone-containing vinylic macromer, a silicone-containing prepolymer, a hydrophilic vinylic monomer, a hydrophobic vinylic monomer, a crosslinking agent (a compound having a molecular weight of about 700 Dal tons or less and containing at least two ethylenically unsaturated groups), a free-radical initiator (photoinitiator or thermal initiator), or a hydrophilic vinylic macromer/prepolymer. A SiHy contact lens formulation can also comprise other necessary components known to a person skilled in the art, such as, for example, a UV-absorbing agent, a visibility tinting agent (e.g., dyes, pigments, or mixtures thereof), antimicrobial agents (for example, silver nanoparticles), a bioactive agent, leachable lubricants, leachable tear-stabilizing agents, and combinations thereof.

Any suitable silicone-containing vinylic monomers may be used in formulating the lens-forming material 108. Examples of silicone-containing vinylic monomers include N-[tris(trimethylsiloxy)silylpropyl]-(meth)acrylamide, N-[tris(dimethylpropylsiloxy)-silylpropyl]-(meth)acrylamide, N-[tris(dimethylphenylsiloxy)silylpropyl](meth)acrylamide, N-[tris(dimethylethylsiloxy)silylpropyl](meth)acrylamide, N-(2-hydroxy-3-(3-(bis(trimethylsilyloxy)methylsilyl)propyloxy)propyl)-2-methyl acrylamide; N-(2-hydroxy-3-(3-(bis(trimethylsilyloxy)methylsilyl)propyloxy)propyl)acrylamide; N,N-bis[2-hydroxy-3-(3-(bis(trimethylsilyloxy)methylsilyl)propyloxy)propyl]-2-methyl acrylamide; N,N-bis[2-hydroxy-3-(3-(bis(trimethylsilyloxy)methylsilyl)propyloxy)propyl]acrylamide; N-(2-hydroxy-3-(3-N-(2-hydroxy-3-(3-(tris(trimethylsilyloxy)silyl)propyloxy)propyl)-2-methyl acrylamide; (tris(trimethylsilyloxy)silyl)propyloxy)propyl)acrylamide; N,N-bis[2-hydroxy-3-(3-(tris(trimethylsilyloxy)silyl)propyloxy)propyl]-2-methyl acrylamide; N,N-bis[2-hydroxy-3-(3-(tris(trimethylsilyloxy)silyl)propyloxy)propyl]acrylamide; N-[2-hydroxy-3-(3-(t-butyldimethylsilyl)propyloxy)propyl]-2-methyl acrylamide; N-[2-hydroxy-3-(3-(t-butyldimethylsilyl)propyloxy)propyl]acrylamide; N,N-bis[2-hydroxy-3-(3-(t-butyldimethylsilyl)propyloxy)propyl]-2-methyl acrylamide; N,N-bis[2-hydroxy-3-(3-(t-butyldimethylsilyl)propyloxy)propyl]acrylamide; 3-methacryloxy propylpentamethyldisiloxane, tris(trimethylsilyloxy)silylpropyl methacrylate (TRIS), (3-methacryloxy-2-hydroxypropyloxy)propylbis(trimethylsiloxy)methylsilane), (3-methacryloxy-2-hydroxypropyloxy)propyltris(trimethylsiloxy) silane, 3-methacryloxy-2-(2-hydroxyethoxy)-propyloxy)propylbis(trimethylsiloxy)methylsilane, N-2-methacryloxyethyl-O-(methyl-bistrimethylsiloxy-3-propyl)silylcarbamate, 3-(trimethylsilyl)propylvinyl carbonate, 3-(vinyloxycarbonylthio)propyl-tris(trimethyl-siloxy) silane, 3-[tris(trimethylsiloxy)silyl]propylvinyl carbamate, 3-[tris(trimethylsiloxy)silyl]propylallyl carbamate, 3-[tris(trimethylsiloxy)silyl]propyl vinyl carbonate, t-butyldimethyl-siloxyethyl vinyl carbonate; trimethylsilylethyl vinyl carbonate, and trimethylsilylmethylvinyl carbonate. Some example siloxane-containing (meth)acrylamide monomers are N-[tris(trimethylsiloxy)silylpropyl]acrylamide, TRIS, N-[2-hydroxy-3-(3-(tbutyldimethylsilyl)propyloxy)propyl]acrylamide, or combinations thereof.

A class of silicone-containing vinylic monomers or macromers is polysiloxane-containing vinylic monomers or macromers. Examples of such polysiloxane-containing vinylic monomers or macromers are monomethacrylated or monoacrylated polydimethylsiloxanes of various molecular weight (e.g., mono-3-methacryloxypropyl terminated, mono-butyl terminated polydimethylsiloxane or mono-(3-methacryloxy-2-hydroxypropyloxy)propyl terminated, mono-butyl terminated polydimethylsiloxane); dimethacrylated or diacrylated polydimethylsiloxanes of various molecular weight; vinyl carbonate-terminated polydimethylsiloxanes; vinyl carbamate-terminated polydimethylsiloxane; vinyl terminated polydimethylsiloxanes of various molecular weight; methacrylamide-terminated polydimethylsiloxanes; acrylamide-terminated polydimethylsiloxanes; acrylate-terminated polydimethylsiloxanes; methacrylateterminated polydimethylsiloxanes; bis-3-methacryloxy-2-hydroxypropyloxypropyl polydimethylsiloxane; N,N,N′,N′tetrakis(3-methacryloxy-2-hydroxypropyl)-alpha, omegabis-3-aminopropyl-polydimethylsiloxane; polysiloxanylalkyl (meth)acrylic monomers; siloxane-containing macromer selected from Macromer A, Macromer B, Macromer C, and Macromer D described in U.S. Pat. No. 5,760,100 (herein incorporated by reference in its entirety); the reaction products of glycidyl methacrylate with amino-functional polydimethylsiloxanes; hydroxyl-functionalized siloxane-containing vinylic monomers or macromers; polysiloxane-containing macromers; polysiloxane-containing macromers, or combinations thereof. Di and triblock macromers such as polydimethylsiloxane and polyalkyleneoxides could also be of utility. For example, one might use methacrylate end capped polyethyleneoxide-block-polydimethylsiloxane-block-polyethyleneoxide to enhance oxygen permeability. In at least some embodiments, the polysiloxane-containing vinylic monomers or macromers may include betacon, D6, H4, low Mw CEPDMS, or combinations thereof. Betacon represents a dimethacrylate-terminated chain-extended polydimethylsiloxane, which has two polydimethylsiloxane (PDMS) segments separated by one perfluoropolyether (PFPE) via diurethane linkages between PDMS and PFPE segments and two urethane linkages each located between one terminal methacrylate group and one PDMS segment. D6 represents a monobutyl-terminated monomethacryloxypropyl-terminated polydimethylsiloxane (Mw~761 g/mol). H4 represents a glycerol-functionalized polydimethylsiloxane (Mw~11600 g/mol). Low Mw CEPDMS represents a dimethacrylate-terminated chain-extended polydimethylsiloxane (Mw~6000 g/mol), which has three PDMS segments linked via diurethane linkages between two PDMS segments and two urethane linkages each located between one terminal methacrylate group and one PDMS segment. Suitable monofunctional hydroxyl-functionalized siloxane-containing vinylic monomers/macromers and suitable multifunctional hydroxylfunctionalized siloxane-containing vinylic monomers/macromers are commercially available from Gelest, Inc, Morrisville, Pa.

Another class of silicone-containing macromers is silicone-containing prepolymers comprising hydrophilic segments and hydrophobic segments. Any suitable silicone-containing prepolymers with hydrophilic segments and hydrophobic segments may be used.

Examples of hydrophilic vinylic monomers are N,N-dimethylacrylamide (DMA), N,N-dimethylmethacrylamide (DMMA), 2-acrylamidoglycolic acid, 3-acryloylamino-1-propanol, N-hydroxyethyl acrylamide, N-[tris(hydroxymethyl)methyl]-acrylamide, N-methyl-3-methylene-2-pyrrolidone, 1-ethyl-3-methylene-2-pyrrolidone, 1-methyl-5-methylene-2-pyrrolidone, 1-ethyl-5-methylene-2-pyrrolidone, 5-methyl-3-methylene-2-pyrrolidone, 5-ethyl-3-methylene-2-pyrrolidone, 1-n-propyl-3-methyl-ene-2-pyrrolidone, 1-n-propyl-5-methylene-2-pyrrolidone, 1-isopropyl-3-methylene-2-pyrrolidone, 1-isopropyl-5-methylene-2-pyrrolidone, 1-n-butyl-3-methylene-2-pyrrolidone, 1-tert-butyl-3-methylene-2-pyrrolidone, 2-hydroxyethyl methacrylate (HEMA), 2-hydroxyethyl acrylate (HEA), hydroxypropyl acrylate, hydroxypropyl methacrylate (HPMA), trimethylammonium 2-hydroxy propylmethacrylate hydrochloride, aminopropyl methacrylate hydrochloride, dimethylaminoethyl methacrylate (DMAEMA), ethylene glycol methyl ether methacrylate (EGMA), glycerol methacrylate (GMA), N-vinyl-2-pyrrolidone (NVP), allyl alcohol, vinylpyridine, a C₁-C₄-alkoxy polyethylene glycol (meth)acrylate having a weight average molecular weight of up to 1500, methacrylic acid, N-vinyl formamide, N-vinyl acetamide, N-vinyl isopropylamide, N-vinyl-N-methyl acetamide, allyl alcohol, N-vinyl caprolactam, or combinations thereof.

Examples of hydrophobic vinylic monomers include methylacrylate, ethyl-acrylate, propylacrylate, isopropylacrylate, cyclohexylacrylate, 2-ethylhexylacrylate, methyl methacrylate (MMA), ethylmethacrylate, propylmethacrylate, vinyl acetate, vinyl propionate, vinyl butyrate, vinyl valerate, styrene, chloroprene, vinyl chloride, vinylidene chloride, acrylonitrile, I-butene, butadiene, methacrylonitrile, vinyl toluene, vinyl ethyl ether, perfluorohexylethyl-thio-carbonylaminoethylmethacrylate, isobornyl methacrylate, trifluoroethyl methacrylate, hexafluoro-isopropyl methacrylate, hexafluorobutyl methacrylate, or combinations thereof.

Examples of cross-linking agents include tetraethyleneglycol diacrylate, triethyleneglycol diacrylate, ethyleneglycol diacylate, diethyleneglycol diacrylate, tetraethyleneglycol dimethacrylate, triethyleneglycol dimethacrylate, ethyleneglycol dimethacylate, diethyleneglycol dimethacrylate, trimethylopropane trimethacrylate, pentaerythritol tetramethacrylate, neopentyl glycol dimethacrylate, bisphenol A dimethacrylate, vinyl methacrylate, ethylenediamine dimethyacrylamide, ethylenediamine diacrylamide, glycerol dimethacrylate, triallyl isocyanurate, triallyl cyanurate, allylmethacrylate, allylmethacrylate, 1,3-bis(methacrylamidopropyl)-1,1,3,3-tetrakis(trimethylsiloxy)disiloxane, N,N′methylenebisacrylamide, N,N′methylenebismethacrylamide, N,N′-ethylenebisacrylamide, N,N′-ethylenebismethacrylamide, 1,3-bis(N-methacrylamidopropyl)-1,1,3,3-tetrakis-(trimethylsiloxy)disiloxane, tetrakis(trimethylsiloxy)disiloxane, 1,3-bis(methacrylamidobutyl)-1,1,3,3-1,3-bis(acrylamidopropyl)-1,1,3,3-tetrakis(trimethylsiloxy)disiloxane, 1,3-bis(methacryloxyethylureidopropyl)-1,1,3,3-tetrakis(trimethylsiloxy)disiloxane, or combinations thereof. An example cross-linking agent is tetra(ethyleneglycol)diacrylate, tri(ethyleneglycol)diacrylate, ethyleneglycol diacrylate, di(ethyleneglycol)diacrylate, methylenebisacrylamide, triallyl isocyanurate, triallyl cyanurate or combinations thereof. The amount of a crosslinking agent used is expressed in the weight content with respect to the total polymer and may be from about 0.05% to about 4%, such as about 0.1% to about 2%.

Examples of suitable thermal initiators include 2,2′-azobis(2,4-dimethylpentanenitrile), 2,2′-azobis(2-methylpropanenitrile), 2,2′-azobis(2-methylbutanenitrile), peroxides such as benzoyl peroxide, the like, or combinations thereof. For example, the thermal initiator is 2,2′-azobis(isobutyronitrile) (AIBN).

Suitable photoinitiators are benzoin methyl ether, diethoxyacetophenone, a benzoylphosphine oxide, 1-hydroxycyclohexyl phenyl ketone and F and Irgacur types, for example, Darocur 1173®, Irgacur 2959® or combinations thereof. Examples of benzoylphosphine initiators include 2,4,6-trimethylbenzoyldiphenylophosphine oxide; bis-(2,6-dichlorobenzoyl)-4-N-propylphenylphosphine oxide; and bis-(2,6-dichlorobenzoyl)-4-N-butylphenylphosphine oxide. Reactive photoinitiators, which can be incorporated, for example, into a macromer or can be used as a special monomer are also suitable. The polymerization can then be triggered by actinic radiation, for example light, in particular UV light of a suitable wavelength. The spectral requirements can be controlled accordingly, if appropriate, by addition of suitable photosensitizers.

Any suitable polymerizable UV-absorbing agents may be used in the formulation of the lens-forming material 108, the UV curable ink, or the insert lens formulation. For example, a polymerizable UV-absorbing agent comprises a benzotriazole-moiety or a benzophenone-moiety. Examples of polymerizable UV absorbers include 2-(2-hydroxy-5-vi-nylphenyl)-2H-benzotriazole, 2-(2-hydroxy-5-acrylyloxyphenyl)-2H-benzotriazole, 2-(2-hydroxy-3-methacrylamidomethyl-5-tert octylphenyl)benzotriazole, 2-(2′hydroxy-5′-methacrylamidophenyl)-5-chlorobenzotriazole, 2-(2′-hydroxy-5′-methacrylamidophenyl)-5-methoxybenzotriazole, 2-(2′-hydroxy-5′-methacryloxypropyl-3′-t-butylphenyl)-5-chlorobenzotriazole, 2-(2′-hydroxy-5′-methacryloxyethylphenyl)benzotriazole, 2-(2′-hydroxy-5′methacryloxypropylphenyl)benzotriazole, 2-hydroxy-4-acryloxy alkoxy benzophenone, 2-hydroxy-4-methacryloxy alkoxy benzophenone, allyl-2-hydroxybenzophenone, 2-hydroxy-4-methacryloxy benzophenone, or combinations thereof.

The bioactive agent is any compound that can prevent a malady in the eye or reduce the symptoms of an eye malady. The bioactive agent can be a drug, an amino acid (e.g., taurine, glycine, etc.), a polypeptide, a protein, a nucleic acid, or any combination thereof. Examples of drugs useful herein include rebamipide, ketotifen, olaptidine, cromoglycolate, cyclosporine, nedocromil, levocabastine, lodoxamide, ketotifen, the pharmaceutically acceptable salt or ester thereof, or combinations thereof. Other examples of bioactive agents include 2-pyrrolidone-5-carboxylic acid (PCA), alpha hydroxyl acids (e.g., glycolic, lactic, malic, tartaric, mandelic and citric acids and salts thereof, etc.), linoleic and gamma linoleic acids, and vitamins (e.g., B5, A, B6, etc.), or combinations thereof.

Examples of leachable lubricants include mucin-like materials (e.g., polyglycolic acid) and noncrosslinkable hydrophilic polymers (i.e., without ethylenically unsaturated groups). Any hydrophilic polymers or copolymers without any ethylenically unsaturated groups can be used as leachable lubricants. Examples of noncrosslinkable hydrophilic polymers include polyvinyl alcohols (PVAs), polyamides, polyimides, polylactone, a homopolymer of a vinyl lactam, a copolymer of at least one vinyl lactam in the presence or in the absence of one or more hydrophilic vinylic comonomers, a homopolymer of acrylamide or methacrylamide, a copolymer of acrylamide or methacrylamide with one or more hydrophilic vinylic monomers, polyethylene oxide (i.e., polyethyleneglycol (PEG)), a polyoxyethylene derivative, poly-N—N-dimethylacrylamide, polyacrylic acid, poly 2 ethyl oxazoline, heparin polysaccharides, polysaccharides, or combinations thereof. The weight-average molecular weight Mw of the noncrosslinkable hydrophilic polymer can be from 5,000 to 100,000.

Examples of leachable tear-stabilizing agents include phospholipids, monoglycerides, diglycerides, triglycerides, glycolipids, glyceroglycolipids, sphingolipids, sphingo-glycolipids, fatty alcohols, fatty acids, mineral oils, or combinations thereof. For example, a tear stabilizing agent is a phospholipid, a monoglyceride, a diglyceride, a triglyceride, a glycolipid, a glyceroglycolipid, a sphingolipid, a sphingo-glycolipid, a fatty acid having 8 to 36 carbon atoms, a fatty alcohol having 8 to 36 carbon atoms, or combinations thereof.

In accordance with the disclosure, the SiHy lens formulation, the UV curable ink, or the insert lens formulation can be a solution or a melt at a temperature from about 20° C. to about 85° C. For example a polymerizable composition is a solution of all desirable components in a suitable solvent, or a mixture of suitable solvents.

A SiHy lens formulation, a UV curable ink, or an insert lens formulation can be prepared by dissolving all of the desirable components in any suitable solvent, such as water, a mixture of water and one or more organic solvents miscible with water, an organic solvent, or a mixture of one or more organic solvents, as known to a person skilled in the art.

Examples of organic solvents include tetrahydrofuran, ethanol, tripropylene glycol methyl ether, dipropylene glycol methyl ether, ethylene glycol n-butyl ether, ketones (e.g., acetone, methyl ethyl ketone, etc.), diethylene glycol n-butyl ether, diethylene glycol methyl ether, ethylene glycol phenyl ether, propylene glycol methyl ether, propylene glycol methyl ether acetate, dipropylene glycol methyl ether acetate, propylene glycol n-propyl ether, dipropylene glycol n-propyl ether, tripropylene glycol n-butyl ether, propylene glycol n-butyl ether, dipropylene glycol n-butyl ether, tripropylene glycol n-butyl ether, propylene glycol phenyl ether dipropylene glycol dimethyl ether, polyethylene glycols, polypropylene glycols, ethyl acetate, butyl acetate, amyl acetate, methyl lactate, ethyl lactate, i-propyl lactate, methylene chloride, 2-butanol, 1-propanol, 2-propanol, menthol, cyclohexanol, cyclopentanol and exonorborneol, 2-pentanol, 3-pentanol, 2-hexanol, 3-hexanol, 3-methyl-2-butanol, 2-heptanol, 2-octanol, 2-nonanol, 2-decanol, 3-octanol, norborneol, tert-butanol, tert-amyl alcohol, 2-methyl-2-pentanol, 2,3-dimethyl-2-butanol, 3-methyl-3-pentanol, 1-methylcyclohexanol, 2-methyl-2-hexanol, 3,7-dimethyl-3-octanol, 1-chloro-2-methyl-2-propanol, 2-methyl-2-heptanol, 2-methyl-2-octanol, 2-2-methyl-2-nonanol, 2-methyl-2-decanol, 3-methyl-3-hexanol, 3-methyl-3-heptanol, 4-methyl-4-heptanol, 3-methyl-3-octanol, 4-methyl-4-octanol, 3-methyl-3-nonanol, 4-methyl-4-nonanol, 3-methyl-3-octanol, 3-ethyl-3-hexanol, 3-methyl-3-heptanol, 4-ethyl-4-heptanol, 4-propyl-4-heptanol, 4-isopropyl-4-heptanol, 2,4-dimethyl-2-pentanol, 1-methylcyclopentanol, 1-ethylcyclopentanol, 1-ethylcyclopentanol, 3-hydroxy-3-methyl-1-butene, 4-hydroxy-4-methyl-1-cyclopentanol, 2-phenyl-2-propanol, 2-methoxy-2-methyl-2-propanol 2,3,4-trimethyl-3-pentanol, 3,7-dimethyl-3-octanol, 2-phenyl-2-butanol, 2-methyl-1-phenyl-2-propanol and 3-ethyl-3-pentanol, 1-ethoxy-2-propanol, 1-methyl-2-propanol, t-amyl alcohol, isopropanol, 1-methyl-2-pyrrolidone, N,N-dimethylpropionamide, dimethyl formamide, dimethyl acetamide, dimethyl propionamide, N-methyl pyrrolidinone, or combinations thereof.

In at least some embodiments, the soft lens body 311, formed from the lens-forming material 108, may include a polymer formed from a glycerol-functionalized polydimethylsiloxane, such as H4, TRIS, and dimethylacetamide. The soft lens body 311 may include about 15 wt % to about 40 wt % of a glycerol-functionalized polydimethylsiloxane unit, such as about 20 wt % to about 35 wt %, about 25 wt % to about 35 wt %, or about 25 wt % to about 30 wt %. The soft lens body 311 may further include about 5 wt % to about 25 wt % of TRIS units, such as about 10 wt % to about 25 wt %, about 10 wt % to about 20 wt %, about 15 wt % to about 20 wt %, or about 10 wt % to about 15 wt %. The soft lens body 311 may further include about 10 wt % to about 30 wt % of dimethylacetamide units, such as about 15 wt % to about 30 wt %, about 15 wt % to about 25 wt %, or about 15 wt % to about 20 wt %.

Numerous SiHy lens formulations have been described in numerous patents and patent applications published by the filing date of this application. All of these SiHy lens formulations can be used in obtaining the lens-forming material 108, which in turn becomes the soft lens body 311 of a SiHy contact lens 100 of the disclosure. In at least some embodiments, a SiHy lens formulation for making commercial SiHy lenses, such as, lotrafilcon A, lotrafilcon B, balafilcon A, galyfilcon A, senofilcon A, narafilcon A, narafilcon B, comfilcon A, enfilcon A, asmofilcon A, filcon II 3, or combinations thereof, may be used.

### Methods

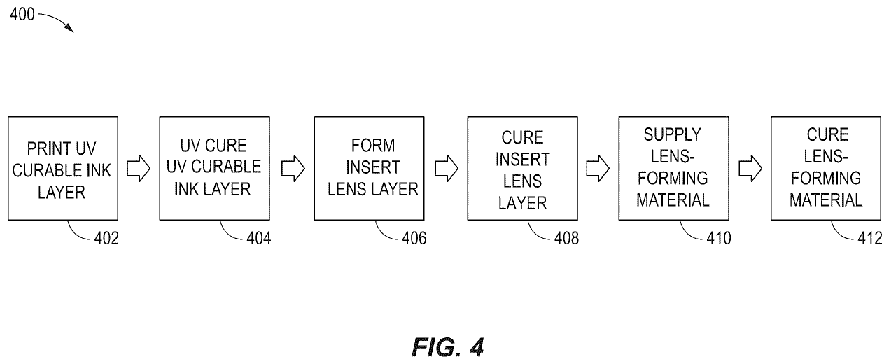

FIG. 4 is a flow diagram depicting a method 400 for forming an embedded SiHy contact lens, according to some embodiments. In operation 402, a pigmented layer 106 is printed on the back curve of a lens mold, outside of the optic zone 207, for example, via pad printing using a ultraviolet (UV) curable ink. In operation 404, the pigmented layer 106 is cured with UV light. In operation 406, the insert lens layer 104 is formed in the lens mold, such that the insert lens layer 104 is disposed over the cured pigmented layer 106. In operation 408, the insert lens layer 104 is cured to form a hard insert lens 310. In operation 410, a lens forming material is supplied such that the hard insert lens 310 is suspended in the lens-forming material 108. In operation 412, the lens-forming material 108 is cured forming the soft lens body 311.

In various embodiments, before performing operation 402 of method 400, the lens mold may be surface treated with a corona treatment, a plasma treatment, and/or a vacuum UV treatment to enhance the surface energies of the lens mold. In some embodiments, the surface treatment may enhance the pigmented layer 106 adhesion to the lens mold and prevent premature removal of the pigmented layer 106 during later steps.

The method 400 may be performed using any suitable polypropylene lens mold. Suitable lens molds may include those employed in cast molding or spin casting. For example, in at least one embodiment, a lens mold (for cast molding) includes at least two mold sections (or portions) or mold halves, i.e. first and second mold halves. The first mold half defines a first molding (or optical) surface and the second mold half defines a second molding (or optical) surface. The first and second mold halves are configured to receive each other such that a lens-forming cavity is formed between the first molding surface and the second molding surface. The molding surface of a mold half is the cavity-forming surface of the lens mold and is in direct contact with lens-forming material. In at least some embodiments, a lens mold having two mold halves is used during method 400. The first molding surface of the first mold half is a back curve used to mold the posterior surface 102 of the SiHy contact lens 100. The back curve of the first mold half is a convex curve. The second molding surface of the second mold half is a front curve used to mold the anterior surface 101 of the SiHy contact lens 100. The front curve of the second mold half is a concave curve.

In at least some embodiments, in operation 402, the pigmented layer 106 is pad printed onto the back curve of the first mold half using a UV curable ink. In some embodiments, the pigmented layer 106 may be pad printed around and outside of the optic zone of the lens mold to at least partially cover the iris section of the lens mold. In at least one embodiment, the pigmented layer 106 is pad printed as an iris pattern, such as an outer starburst pattern, an inner starburst pattern, and/or a limbal ring. In some embodiments, a single pigmented layer 106 is pad printed on the back curve of the first mold half. In other embodiments, a plurality of pigmented layers 106 each having a pattern, are pad printed on the back curve of the first mold half.

An example of pad printing follows. An image, such as a pattern used in operation 402, is etched into metal to form a cliche. The cliche is placed in a printer. Once in the printer, the cliche is inked by either an open inkwell doctoring system or by a closed ink cup sliding across the image. Then, a silicone pad picks up the inked image from the cliche and transfers the image to the lens mold. The silicone pads include a material comprising silicone that can vary in elasticity. The properties of the silicone material permit the ink(s) to stick to the pad temporarily and fully release from the pad when the pad contacts a contact lens or a lens mold. Appropriate pad-transfer printing structures include Tampotype printing structures (Tampa vario 90/130), rubber stamps, thimbles, doctor's blade, direct printing, or transfer printing as they are known in the art.

Any suitable silicone pad can be used in the present disclosure. Silicone pads are commercially available. However, different pads could give different print qualities. A person skilled in the art will know how to select a pad for a given ink.

Cliche can include ceramics or metals (e.g., steel). In embodiments in which a cliche includes a steel, it would be desirable to neutralize the pH of a water-based ink (e.g., adjusted pH to 6.8-7.8) by adding a buffer (such as, for example, phosphate salts). Images can be etched into a cliche according to any methods known to a person skilled in the art, for example, by chemical etching or laser ablation or the like. It is also desirable to clean cliches after use via standard cleaning techniques known to a person skilled in the art, such as, for example, immersion in a solvent, sonication, or mechanical abrasion.

In at least some embodiments, the pigmented layer 106 is cured in operation 404 with UV light. The UV light may include UVA (315-400 nm), UVB (280-315 nm), UVC (100-280 nm), and UVV (395 nm to 455 nm). In at least some embodiments, the UV light is a high intensity broad-spectrum UV light. In at least some embodiments, the UV light has a spectral output of about 1,000 mW/cm² to about 3,000 mW/cm², such as about 1,200 mW/cm² to about 3,000 mW/cm², about 1,500 mW/cm² to about 3,000 mW/cm², about 2,000 mW/cm² to about 3,000 mW/cm², or about 2,500 mW/cm² to about 3,000 mW/cm². In at least one embodiment, the UV light is a UV fusion system. In at least some embodiments the UV light may include UVA having an average intensity of about 1,000 mW/cm², UVB having an average intensity of about 1,000 mW/cm², UVC having an average intensity of about 350 mW/cm², UVV having an average intensity of about 1,200 mW/cm², or combinations thereof. In at least some embodiments, the pigmented layer 106 may be cured with UV light for about 15 seconds to about 5 minutes at a temperature of about 20° C. to about 35° C. In some embodiments, a plurality of pad printed pigmented layers 106 are cured at once. In other embodiments, each pigmented layer 106 of a plurality of pigmented layers 106 is individually cured before the next pigmented layer 106 is pad printed. Curing the pigmented layer 106 before operation 406 sets the pigment and prevents smudging, resulting in a sharper image in the final lens.

In at least some embodiments, in operation 406, the insert lens layer 104 is formed in the lens mold. In at least some embodiments, the insert lens layer 104 is formed by casting the insert lens layer 104 in the lens mold. In at least some embodiments, forming the insert lens layer 104 includes supplying the insert lens formulation for the insert lens layer 104 to the front curve of the second mold half and positioning the back curve of the first mold half, containing the cured pigmented layer 106, on the front curve of the of the second mold half where it remains for subsequent curing. The back curve of the first mold half is positioned such that the insert lens layer 104 is disposed over the cured pigmented layer 106.

In at least some embodiments, the insert lens layer 104 is cured in operation 408 with UV light to form a hard insert lens 310. In at least some embodiments, the UV light is a high intensity broad-spectrum UV light. The UV light may include UVA (315-400 nm), UVB (280-315 nm), UVC (100-280 nm), and UVV (395 nm to 455 nm). In at least some embodiments, the UV light may have an average intensity of about 1 mW/cm² to about 20 mW/cm², such as about 1 mW/cm² to about 15 mW/cm², about 1 mW/cm² to about 10 mW/cm², about 2 mW/cm² to about 8 mW/cm², or about 2 mW/cm² to about 5 mW/cm². In at least one embodiment, the UV light is a UV fusion system. In at least some embodiments, the insert lens layer 104 may be cured with UV light having an average intensity of about 2 mW/cm² to about 10 mW/cm², for about 0.5 hours to about 2 hours at a temperature of about 20° C. to about 35° C.

In at least some embodiments, the insert lens layer 104 is thermally cured in operation 408 to form a hard insert lens 310. Thermally curing the insert lens layer 104 may include, placing the lens mold containing the insert lens layer 104 in a curing oven under flowing nitrogen. The curing oven is purged with nitrogen gas for about 15 minutes to about 60 minutes, such as about 15 minutes to about 45 minutes, or about 15 minutes to about 30 minutes, at a temperature of about 20° C. to about 30° C., such as about 25° C. In at least some embodiments, the curing oven is purged to an oxygen level of about 0% to about 1% by volume, such as about 0.1% to about 0.9%, or about 0.5%. In at least some embodiments, the curing oven is purged to an oxygen level of about 0 ppm to about 2,000 ppm of oxygen, such as about 1 ppm to about 2,000 ppm, about 10 ppm to about 1,500 ppm, about 100 ppm to about 1,000 ppm, or about 1,000 ppm. The lens mold is heated in the curing oven at a temperature of about 45° C. to about 65° C., such as about 55° C., for about 15 minutes to about 30 minutes for an intermediate temperature soak. In at least some embodiments, the lens mold is further subjected to an elevated temperature soak after the intermediate temperature soak. The elevated temperature soak includes heating the lens mold in the curing oven at a temperature of about 70° C. to about 90° C., such as about 80° C., for about 15 minutes to about 30 minutes. In at least some embodiments, the lens mold is further subjected to a high temperature soak after the elevated temperature soak. The high temperature soak includes heating the lens mold in the curing oven at a temperature of about 95° C. to about 110° C., such as about 100° C., for about 15 minutes to about 30 minutes. In at least some embodiments, one or more of the intermediate temperature soak, the elevated temperature soak, and the high temperature soak are performed under a constant nitrogen purge.

Operations 402-408 allow the print of the UV curable ink layer to be incorporated into the lens without a pre-soak step. The lack of a pre-soak step reduces the risk of printed dot degradation due to pigment migration into the lens matrix both parallel and perpendicular to the lens mold, resulting in improved print resolution. In addition, the position of the print pattern is controlled by the lens mold design and the initial printing position, not the migration of the printed dots into the lens matrix, which allows for higher consistency between printed contact lenses.

In at least some embodiments, the hard insert lens 310 is demolded or de-lensed from the lens mold before operation 410. The hard insert lens 310 may be dry de-lensed using ultrasonic. In at least some embodiments, the hard insert lens 310 is dry de-lensed using a combination of cold temperature and ultrasonic.

In at least some embodiments, in operation 410, the hard insert lens 310 is positioned in a second lens mold. The second lens mold may be an embedded mold having support posts to control the offset of the hard insert lens 310 from the front curve and the back curve of the second lens mold. In at least some embodiments, the hard insert lens 310 is positioned on the support posts. The formulation of the lens-forming material 108 is supplied to the front curve of the second lens mold, such that the hard insert lens 310 is suspended in the lens-forming material 108. The back curve of the second lens mold is positioned on the front curve of the second lens mold where it remains for subsequent curing. The back curve of the second lens mold is positioned such that the lens-forming material 108 encapsulates the hard insert lens 310.

In at least some embodiments, the lens-forming material 108 is cured in operation 412 with UV light to form the soft lens body 311. The UV light curing may be single sided. In at least some embodiments, the UV light is a high intensity broad-spectrum UV light. The UV light may include UVA (315-400 nm), UVB (280-315 nm), UVC (100-280 nm), and UVV (395 nm to 455 nm). In at least some embodiments. In at least one embodiment, the UV light is a UV fusion system. In at least some embodiments, the UV light has a wavelength of about 365 nm. The UV light may have an average intensity of about 1 mW/cm² to about 20 mW/cm², such as about 1 mW/cm² to about 15 mW/cm², about 1 mW/cm² to about 10 mW/cm², about 2 mW/cm² to about 8 mW/cm², or about 2 mW/cm² to about 5 mW/cm². In at least some embodiments, the lens-forming material 108 may be cured with UV light having an average intensity of about 2 mW/cm² to about 15 mW/cm², for about 5 minutes to about 40 minutes at a temperature of about 20° C. to about 35° C. For example, in at least one embodiment, the lens-forming material 108 may be cured with UV light having an average intensity of about 2 mW/cm² to about 5 mW/cm², for about 10 minutes. In another embodiment, the lens-forming material 108 may be cured with UV light having an average intensity of about 2 mW/cm² to about 13 mW/cm², for about 35 minutes.

In at least some embodiments, the lens-forming material 108 is heat cured in operation 412 to form the soft lens body 311. In various embodiments, heat curing the lens-forming material 108 includes placing the second lens mold containing the lens-forming material 108 in a curing oven under flowing nitrogen. The curing oven is purged with nitrogen gas for about 15 minutes to about 60 minutes, such as about 15 minutes to about 45 minutes, or about 15 minutes to about 30 minutes, at a temperature of about 20° C. to about 30° C., such as about 25° C. In at least some embodiments, the curing oven is purged to an oxygen level of about 0% to about 1% by volume, such as about 0.1% to about 0.9%, or about 0.5%. In at least some embodiments, the curing oven is purged to an oxygen level of about 0 ppm to about 2,000 ppm of oxygen, such as about 1 ppm to about 2,000 ppm, about 10 ppm to about 1,500 ppm, about 100 ppm to about 1,000 ppm, or about 1,000 ppm. The second lens mold containing the lens-forming material 108 is heated in the curing oven at a temperature of about 45° C. to about 65° C., such as about 55° C., for about 15 minutes to about 30 minutes for an intermediate temperature soak. In at least some embodiments, the second lens mold is further subjected to an elevated temperature soak after the intermediate temperature soak. The elevated temperature soak includes heating the second lens mold in the curing oven at a temperature of about 70° C. to about 90° C., such as about 80° C., for about 15 minutes to about 30 minutes. In at least some embodiments, the second lens mold is further subjected to a high temperature soak after the elevated temperature soak. The high temperature soak includes heating the second lens mold in the curing oven at a temperature of about 95° C. to about 110° C., such as about 100° C., for about 15 minutes to about 30 minutes. In at least some embodiments, one or more of the intermediate temperature soak, the elevated temperature soak, and the high temperature soak are performed under a constant nitrogen purge.

In at least some embodiments, after operation 412, back end processing including dry demolding and/or de-lensing is performed followed by in package coating/autoclave sterilization. In at least some embodiments, the final contact lens may be dry de-lensed using ultrasonic. In at least some embodiments, the final contact lens is dry de-lensed using a combination of cold temperature and ultrasonic.

Overall, the present disclosure provides a hybrid hard-soft SiHy contact lens having a layer of pigment printed on a hard insert lens that is encapsulated by a soft lens body, reducing wearer discomfort by preventing pigment abrasions on the eye or inner eyelid, and methods for forming the same. In at least some embodiments, a hard insert lens, printed with a pigmented layer, masks abnormal shapes of astigmatic corneas, since the embedded hard insert lens does not conform to the shape of the cornea. In at least some embodiments, the embedded hard insert lens aids in trapping the pigmented layer, preventing the pigmented layer from defusing towards or otherwise contacting the eye of the wearer, as the pigmented layer is fully embedded within the soft lens body. The complete encapsulation of the pigmented layer prevents pigment abrasions on the eye or inner eyelid, leading to a more comfortable SiHy contact lens.

Although various embodiments of the disclosure have been described using specific terms, devices, and methods, such descriptions are for illustrative purposes only. The words used are words of description rather than of limitation. It is to be understood that changes and variations may be made by those skilled in the art without departing from the spirit or scope of the present disclosure, which is set forth in the following claims. In addition, it should be understood that aspects of the various embodiments may be interchanged either in whole or in part. Therefore, the spirit and scope of the appended claims should not be limited to the description of the preferred versions contained therein.

Some implementations and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Some lower limits, upper limits and ranges appear in one or more claims below.

What is claimed is:

1. A method for making a colored contact lens, comprising:
printing a pigmented layer on a lens mold comprising an optic zone, wherein the pigmented layer is printed outside an outer boundary of the optic zone;
curing the pigmented layer with ultraviolet (UV) light;
forming an insert lens layer, the insert lens layer disposed on the cured pigmented layer;
curing the insert lens layer to form an insert lens having a modulus of about 2 MPa or greater;
suspending the insert lens in a lens-forming material; and
curing the lens-forming material to form a lens body, the insert lens disposed within the lens body.

2. The method of claim 1, wherein the UV light comprises each of UVA light, UVB light, and UVC light.

3. The method of claim 1, wherein the insert lens layer is cured with UV light comprising each of UVA light, UVB light, and UVC light.

4. The method of claim 1, wherein curing the insert lens layer is performed by thermally curing the insert lens layer.

5. The method of claim 1, further comprising de-lensing the insert lens from the lens mold using ultrasonic demolding.

6. The method of claim 1, further comprising positioning the insert lens onto support posts in a second lens mold before suspending the insert lens in the lens-forming material.

7. The method of claim 1, wherein the insert lens layer comprises hexafluoroisopropyl methacrylate, neopentylglycol dimethacrylate, tris(trimethylsilyloxy)silylpropyl methacrylate (TRIS), a polydimethylsiloxane, or any combinations thereof.

8. The method of claim 1, wherein curing the lens-forming material comprises:
heating the lens-forming material at a temperature of about 45° C. to about 65° C.;
heating the lens-forming material at a temperature of about 70° C. to about 90° C.; and
heating the lens-forming material at a temperature of 95° C. to about 110° C.

9. A method for making a contact lens, comprising:
printing a pigmented layer on a back curve of a lens mold;
curing the pigmented layer;
forming an insert lens layer, the insert lens layer disposed on the cured pigmented layer;
curing the insert lens layer to form an insert lens having a modulus of greater than about 2 MPa, wherein the insert lens comprises a pattern disposed on a posterior surface of the insert lens;
suspending the insert lens in a lens-forming material; and
curing the lens-forming material to form a lens body having a modulus of less than about 2 MPa, the insert lens disposed within the lens body.

10. The method of claim 9, further comprising positioning the insert lens onto support posts in a second lens mold before suspending the insert lens in the lens-forming material.

11. The method of claim 9, wherein the lens body comprises a silicone hydrogel.

12. The method of claim 9, wherein the insert lens comprises hexafluoroisopropyl methacrylate units.

13. The method of claim 9, wherein the insert lens comprises a polydimethylsiloxane unit.

14. The method of claim 9, wherein the insert lens comprises about 40 wt % to about 50 wt % of hexafluoroisopropyl methacrylate units, about 5 wt % to about 30 wt % of neopentylglycol dimethacrylate units, and about 40 wt % to about 50 wt % of tris(trimethylsilyloxy)silylpropyl methacrylate (TRIS) units.

15. The method of claim 9, wherein the pigmented layer comprises at least one pigment.

16. A contact lens, comprising:
a lens body having a modulus of less than about 2 MPa;
an insert lens having a modulus of about 2 MPa or greater disposed within the lens body, the insert lens comprising a curve and a vault of about 80 μm to about 120 μm; and
at least one pigmented layer disposed on a posterior surface of the insert lens, wherein the at least one pigmented layer is embedded within the lens body.

17. The contact lens of claim 16, wherein the contact lens does not conform to a shape of a cornea of a wearer.

18. The contact lens of claim 16, wherein the curve of the insert lens masks an abnormal shape of an astigmatic cornea.

19. The contact lens of claim 16, wherein the lens body comprises about 20 wt % to about 35 wt % of glycerol-functionalized polydimethylsiloxane units, about 10 wt % to about 20 wt % of tris(trimethylsilyloxy)silylpropyl methacrylate (TRIS) units, and about 15 wt % to about 25 wt % of dimethylacetamide units.

20. The contact lens of claim 16, wherein the insert lens comprises about 40 wt % to about 50 wt % of hexafluoroisopropyl methacrylate units, about 5 wt % to about 30 wt % of neopentylglycol dimethacrylate units, and about 40 wt % to about 50 wt % of tris(trimethylsilyloxy)silylpropyl methacrylate (TRIS) units.
